(19) United States
(12) Patent Application Publication
(10) Pub. No.: US 2011/0172017 A1
(43) Pub. Date: Jul. 14, 2011

(54) GAME MACHINE, GAME PROGRAM, AND GAME MACHINE CONTROL METHOD

(75) Inventors: Hiroyuki Takahashi, Toyota (JP); Shugo Takahashi, Tokyo (JP); Shuji Shimizu, Tokyo (JP); Kentaro Sako, Tokyo (JP)

(73) Assignee: Camelot Co., Ltd, Tokyo (JP)

(21) Appl. No.: 12/674,250

(22) PCT Filed: Aug. 29, 2008
(86) PCT No.: PCT/JP2008/065599

§ 371 Date: Feb. 19, 2010

(30) Foreign Application Priority Data
Aug. 30, 2007 (JP) 2007-224388

(51) Int. Cl. A63F 13/06

(52) U.S. Cl. 463/39

(57) ABSTRACT

[Problems] To provide a game machine comprising a controller including an acceleration sensor therein, personifiable and treatable as a mascot by using an information output function and expressiveness, and exhibiting an improved capability of entertaining the user gaming.

[Means for Solving Problems] A game machine comprises a game progressing unit 281 repeating according to a predetermined rule an operation signal input turn for receiving an input of an operation signal and an object varying turn for varying the display of an object by computation corresponding to the operation signal so as to progress a game, a controller 1c having an acceleration sensor for sensing the acceleration in a predetermined direction and adapted to output an operation signal according to the sensed acceleration, a speaker 1d provided to the controller 1c and adapted to output sound information, an operation signal evaluating unit 283 for setting an evaluation criterion according to the setting operation by the operator and evaluating the operation signal from the controller 1c with reference to the evaluation criterion, and an output information determining unit 284 for determining the output of the sound information corresponding to the evaluation.

### TECHNICAL FIELD

The present invention relates to a game machine, a game program, and a game machine control method, which receive user operation through a controller with a built-in acceleration sensor and have the game proceed with players or other objects displayed in a screen, for example, when playing in a 3D scene of a sports game such as a golf game, a tennis game or a baseball game, or a 3D scene of a role playing game.

### BACKGROUND ART

Conventionally, television games have been developed in many ways, for example, as home video game dedicated machines, coin-operated arcade game machines and the like, and also as game software which can be run by a general-purpose computer such as a personal computer. On the other hand, with the recent advances in the communications infrastructures, game programs provided through a communication network such as the Internet have become popular as distributed by the so-called online gaming services, which are taking place the conventional game software distribution through recording mediums such as CD-ROM.

One of the above games is a sports simulation game such as a golf game which proceeds on various conditions as given, for example, the shooting direction, the magnitude of impact, the strike point and other setting values relating to the operation of the player, which are input when a player takes a shot. These various conditions are input through a graphic user interface (GUI) displayed in a screen with an input interface such as a mouse or a controller of the game machine.

Meanwhile, in recent years, controllers have been developed which are provided with acceleration sensors capable of detecting acceleration in a predetermined direction to input the various conditions in accordance with the acceleration detected by the acceleration sensors, and TV television game machines and game software have been developed for use in playing with the controllers. When playing this kind of TV television game with such a controller, the operation of the controller can be traced with a player displayed in a screen such that it is possible to feel more realistic operability (for example, refer to Non Patent Literature 1).
Non Patent Literature 1: Nintendo website “Wii Sports—Wii”, [online], [Search on Jul. 6, 2007], Internet <URL: http://www.nintendo.co.jp/wii/rspj/5sports/golf.html>, Nintendo Co., Ltd.

### DISCLOSURE OF THE INVENTION

### Problem to be Solved by the Invention

The controller described in the above non patent literature 1 is provided with an LED, a speaker for outputting sound, a vibrator for generating vibration and an interface for connecting another external device in addition to input devices such as an acceleration sensor and operation buttons. It is possible to output various information on the controller side (at the operator's hand), and make the controller personifiable and treatable as a mascot by using the information output function and expressiveness in combination with the detected acceleration.

On the other hand, the current utilization of the controller does not go much beyond that of a mere input device, and thereby the contribution to the entertainment level of games is still insufficient.

In order to solve the problem as described above, it is an object of the present invention to provide a game machine, a game program, and a game machine control method, which utilize a controller having an acceleration sensor such that the controller is personifiable and treatable as a mascot by using an information output function and expressiveness in addition to the detection of the acceleration thereof, and exhibiting an improved capability of entertaining the user gaming.

### Means to Solve the Problems

In order to accomplish the object as described above, the present invention provides a game machine for proceeding with a game by inputting an operating signal to operate an object displayed in a screen, comprising: a game progressing unit operable to proceed with the game by repeating according to a predetermined rule an operation signal input turn for receiving an input of the operation signal and an object varying turn for varying the display of the object by computation corresponding to the operation signal; a controller provided with an acceleration sensor for detecting acceleration in a predetermined direction and configured to output the operating signal in accordance with the acceleration detected by the acceleration sensor; a sound output unit provided for the controller and operable to output sound information; an operation signal evaluating unit operable to set an evaluation criterion according to the setting operation by the operator and evaluating the operation signal from the controller with reference to the evaluation criterion; and an output information determining unit operable to determine the output of sound information corresponding to the evaluation by the operation signal evaluating unit, wherein, in the operation signal input turn, an operation signal is acquired from the controller; the acquired operation signal is evaluated by the operation signal evaluating unit; the output information determining unit determines sound information in accordance with the evaluation; and the sound information is output through the controller from which the operation signal is input.

In accordance with the present invention as described above, when the operator sets up the position of the controller for inputting an operation signal in the operation signal input turn, the operation signal is evaluated to output sound information from the sound output unit at hand in accordance with the evaluation. Because of this, for example, when the player sets up the position of the controller for taking a shot during playing the golf game, the sound information corresponding to the input operation can be output to personify the controller as an adviser like a caddie.

The present invention also provides a game machine for proceeding with a game by inputting an operating signal to operate an object displayed in a screen, comprising: a game progressing unit operable to proceed with the game by repeating according to a predetermined rule an operation signal input turn for receiving an input of the operation signal through each of a plurality of controllers and an object varying turn for varying the display of the object by computation corresponding to the operation signal; the plurality of controllers each of which is provided with an acceleration sensor for detecting acceleration in a predetermined direction and configured to output the operating signal in accordance with the acceleration detected by the acceleration sensor; a gallery control unit operable to determine the output of sound information or the operation of an object which is assigned to each of the controllers in accordance with the operation signal output from any of the controllers, wherein in the operation signal input turn assigned to one controller, the gallery control unit performs, in response to an operation signal output from another controller, the output of sound information or the operation of an object which is assigned to this another controller.

In accordance with the present invention as described above, when a plurality of operators participate in the game by using controllers respectively, in the turn of one player, other players waiting their turns can output cheers, boos, advice and the like by operating their controllers, and thereby it is possible to personify the controllers of the other players as gallery.

In the invention as described above, it is preferred that the controllers include controllers belonging to other game machines which communicate with this game machine through a communication line, and that the game progressing unit operates to proceed with the same game among the plurality of game machines by synchronous process with the other game machines. In this case, when communicating with remote game machines through a communication line, for example, during playing an online game, it is possible to output cheering, booing and the like in another player's turn.

### Effect of Invention

As has been discussed above, in accordance with the present invention, it is possible to improve the entertainment level of a game with a controller having an acceleration sensor such that the controller is personifiable and treatable as a mascot by using an information output function and expressiveness in addition to the detection of the acceleration thereof.

### BEST MODE FOR CARRYING OUT THE INVENTION

(Configuration of Game Machine)

An embodiment of the present invention will be explained with reference to the accompanying drawings. FIG. 1 is a view for schematically showing the system configuration of a game machine in accordance with the present embodiment. This example of the present embodiment is described in the case where golf game software is run on a gaming hardware 1. Incidentally, while the present invention is applied to the golf game software in the case of the present embodiment, the present invention is not limited thereto, but also applicable to, for example, sports games such as a tennis game and a baseball game, role-playing games including 3D scenes, and any other game software for receiving user operation and having the game proceed with players or other objects displayed in a screen.

The game machine according to the present embodiment is connected to a display 1a, as illustrated in FIG. 1, and used to operate objects displayed in the screen of this display 1a for proceeding with the game. These objects include characters such as a player who plays the golf game in a game scenario, a ball hit by the player, a virtual camera for imaging the three-dimensional space and so forth.

On the other hand, the gaming hardware 1 is provided with a wireless controller 1c capable of transmitting and receiving signals through radio communication as an input device for operating the above objects. This controller 1c includes a built-in acceleration sensor which detects accelerations in the directions of three axes in order to detect the acceleration of the controller 1c in each direction as illustrated in FIG. 2(a) and FIG. 2(b), and outputs operation signals to a communication interface 27 of the gaming hardware 1 in correspondence with the accelerations detected by this acceleration sensor. The direction of gravity exerted on the controller 1c can be detected on the basis of the operation signals output from this controller 1c, and the inclination of this controller 1c can be detected on the basis of this direction as a reference. Also, a motion can be detected on the basis of the centrifugal force exerted on the controller 1c, for example, when swinging a bat, a tennis racket or a golf club. Meanwhile, this controller 1c can be connected with a vibrator, a sound output device, a light emitting device such as an LED, or the like accessory, which is driven in accordance with a control signal transmitted from the gaming hardware.

Furthermore, this controller 1c is provided with a variety of operation buttons 1e such as an arrow key and A/B buttons for input operation, and a speaker 1d for outputting sound information which is received from the gaming hardware 1. In addition, while this controller 1c is provided with a display device such as an LED, it is possible to use, for example, a liquid crystal display device or any other display device. Meanwhile, the controller 1c at the operator's hands is personalized as a guide, a caddie or an adviser with sound, display and vibration by the output function such as the speaker 1d, the LED and the display device, and the driving means such as the vibrator, for example, when performing various operations before starting a golf game or during playing the golf game through a variety of menus (main menu, character selection menu, play mode selection menu, course selection menu and so forth) and the user interface.

The display 1a is a device which outputs image signals and sound signals transmitted from the gaming hardware 1 for enabling viewing of the game screen and listening of the associated sound. Then, a graphic user interface 344 is displayed in the screen of the display 1a for performing the display and operation of the game. The operator can perform the operation of a character through this graphic user interface 344.

The gaming hardware 1 is an arithmetic processing unit equipped with a CPU, and can be realized with a general purpose personal computer such as a personal computer or a dedicated device specialized with necessary functions. The gaming hardware 1 may be a mobile computer, a PDA (Personal Digital Assistance) or a cellular phone.

As illustrated in FIG. 4, this gaming hardware 1 comprises a CPU 2 for performing arithmetic operations, a storage device 12 such as a hard disk for storing data and programs, a display interface (I/F) 14 for connecting a display device such as a display 1a, a data input/output device 15 for inputting and outputting data in a recording medium such as a CD-ROM, a DVD-ROM or a memory card, a communication interface (I/F) 27 for communicating with an input device such as a wireless controller 1c, a light receiving interface (I/F) 1b and so forth.

A variety of modules are built by driving the CPU 2 to run the golf game software. In the context of this document, the term “module” is intended to encompass any function unit capable of performing necessary operation, as implemented with hardware such as a device or an apparatus, software capable of performing the functionality of the hardware, or any combination thereof. More specifically described, the CPU 2 runs the golf game software to build a screen construction unit 22, a 3D configuration unit 23, a GUI control unit 24, an application running unit 25 and a 2D configuration unit 26.

The application running unit 25 is a module for running the programs of the golf game software to proceed with the golf game by making use of objects which are arranged in a 3D virtual space 3. More specifically speaking, the application running unit 25 performs the progress management of the game by repeating predetermined turns with a game progressing unit 281 to be described below in accordance with the rules of golf (OB is counted as one penalty stroke followed by hitting again; when multiple players participate in the game, each player takes a shot in a controlled order; and so forth), the score management on the basis of progress of the golf game, and the arithmetic operation necessary for ballistic simulation of the projectile in the virtual space by calculating the condition of a ball which is struck in accordance with stroke analysis on the basis of the ability parameters of the character and the properties of items, such as a golf club, which are used and selected by each player through an object control unit 252.

Incidentally, while a virtual three-dimensional space 3 is constructed as a three-dimensional representation to make alive the scene and the like in the case of this golf game program, since the display 1a the user views is two-dimensional, the interface is provided for helping the operator to spatially recognize the space by automatically performing the camera work which is moved in the vertical plane along the shooting direction, representing this plane in association with a power gauge, and so forth.

Then, the golf game program receives an operation signal generated by the user operation through the communication interface 27, the light receiving interface (I/F) 1b and the controller 1c, proceeds with the game in accordance with the condition (input data) acquired in response to the operation signal, generates display information items (3D polygons and so forth), displays the imaging screens 31 to 33 as two-dimensional planes in correspondence with various viewing directions, and outputs sound associated with the display.

The 3D configuration unit 23 is a module for virtually constructing the three-dimensional space, and controlling the position coordinates of the objects and the cameras located in the three-dimensional coordinate system 35 in this three-dimensional space 3. The 2D configuration unit 26 is a module for two-dimensionally displaying the three-dimensional space 3 in the imaging screens 31 to 33 in accordance with the field-of-view range of each of the imaging screens 31 to 33 on the basis of the type, area and shape of each imaging screen.

The screen construction unit 22 is a module for acquiring the data of the three-dimensional space 3 constructed by the 3D configuration unit 23, having the 2D configuration unit 26 to perform arithmetic operation of the two-dimensional images in the viewing directions on the basis of operator's operation, and controlling the imaging screens 31 to 33 in correspondence with various viewing directions. Specifically speaking, while virtual cameras are provided for setting the field-of-view ranges in the three-dimensional space 3, the objects imaged by the virtual cameras respectively are displayed in the imaging screens 31 to 33 by the 2D configuration unit 26 respectively as two-dimensional planes on the basis of the positional relationship between the objects and the virtual cameras calculated by the 3D configuration unit 23. Meanwhile, in the case of the present embodiment, the imaging screen 33 is a main screen showing the shooting motion of a player in a full view of a golf course. The main screen includes the GUI 34. Also, the imaging screen 32 is a jump screen in which is imaged the location near the arrival point of the ball, and the imaging screen 31 is a top screen in which is imaged the golf course viewed from above as a bird's-eye view.

The GUI control unit 24 is a module for controlling the graphic user interface (GUI) which is located in the imaging screens 31 to 33 (mainly in the main screen 33 in the case of the present embodiment) for displaying information about the game and enabling the user to perform operation. In the case of the present embodiment, the golf game proceeds in response to the operation of an object (character, ball or the like) displayed in the display 1a through the GUI by the use of the input device 1c.

The GUI 34 comprises graphics mainly displayed in the main imaging screen 33, for example, as an icon 341 indicative of the progress of the golf game (hole number and par type), an icon 342 indicative of the distance and direction to the pin, an icon 343 indicative of how the wind blows, icons 345 indicative of the name and score of the player, an icon 346 indicative of the golf club the operator has selected, an icon 347 indicative of the state of the ball, a guidance icon 348 for performing the settings in regard to the evaluation (guidance) of operation signals, an icon 344 which is operated when striking the ball, and so forth, as illustrated in FIG. 3.

Meanwhile, in the case of the present embodiment, the icon 347 indicative of the state of the ball represents the type of lie where the ball is located (fairway, rough, bunker or the like), the variations in ball behavior (for example, ±3%), the slope angle of the lie (toes pointed uphill or downhill, left foot pointed uphill or downhill, and so forth), and a change in the spin of the ball responsive to the user operation, i.e., a rotation image of the ball when the ball is struck in the current condition. Also, in addition to this, the strike point which is variable corresponding to user operation may be displayed in the icon 347.

In the case of the present embodiment, the parameters input by the user operations through this controller 1c include the striking power and direction of a golf ball 35b which is hit by a character 35a (the strike point on the surface of the ball, face angle, spinning operation and shooting timing). These parameters are input through the operation of the GUI 34 (mainly the icon 344) as input data, and the golf ball 35b which is one of the objects changes in the object coordinate position of the three-dimensional space 3 on the basis of the input data. Incidentally, the input data for shooting operation can be calculated on the basis of a first operation signal as an input value (maximum input value) which varies in response to the operation of the operator of the controller 1c, and a second operation signal as a modification value which modifies the maximum input value (shooting timing, face angle, and the power for swinging the controller).

The guidance icons 348 is a GUI for the operation signal evaluating unit 283, and represented by a character as a controller motif or a character such as a caddie to make it possible to start an operation signal evaluating mode (round lesson) by performing selection operation such as click operation. This operation signal evaluating mode is used to proceed with the game while performing the function to provide a lessen and evaluation about basic operations and specific operations (various hitting operations such as normal shot, power shot, top spin and draw ball), and it is possible to perform the settings of the subject to be evaluated (lessen theme), target point and degree of attainment in accordance with arbitrary setting operation by the operator (selection operation from a lessen list or the like). This lessen theme can be selected on a round basis, hole basis or shot basis, and changed or halted with regard to the theme or the basis even during playing the game. Meanwhile, as the operations in the operation signal evaluating mode such as the start, settings, change and end of round lesson, for example, there are setting operations on usual pause menus or the like, such as click operation on a telop text display area which is displayed if necessary in an upper or lower position of the screen and pressing a predetermined operation button to which this function is assigned, in addition to the above selection operation such as click operation on the character.

Furthermore, once the evaluation object is set up in this operation signal evaluating mode, it is possible to display guidance, advice or target achievement (evaluation point) in terms of a character string such as a telop, a chart or the like whenever playing the game, and output sound information indicative of the evaluation from the controller 1c of the operator who has set the operation signal evaluating mode. The character strings and sound information include, for example, “tilt the remote control downward!”, “hold A button being pressed”, “swing back” or the like advice for a lessen of basic operation, “open the face a bit more (rotate the controller to the right)” or the like advice in advance of taking a shot for a lessen of specific operation such as draw ball, and “good shot!”, “too strong”, “have better timing” or any other evaluation words after taking a shot in accordance with the degree of deviation from the target. Incidentally, a practice swing function is available in this operation signal evaluating mode such that simulation of hitting operation can be performed by taking a practice swing to get the above advice and evaluation without influencing the scoring point of the game. In this practice swing function, sound information appropriate which is advisable to take a practice swing is selected in accordance with the operation signal evaluation resulting from the practice swing, such as “stronger a bit”, “had better aim a little to the right” and “had better change the club”.

On the other hand, describing the icon 344 in detail as illustrated in FIG. 5(a) and FIG. 5(b), a target operation mode for operating the target icon 35c (in the same figure (a)) and a shot operation mode for taking a shot (in the same figure (b)) can be switched from one to another. As this switching operation, it is possible to enter the shot operation mode by tilting the controller 1c downward with the button 1e being pressed. The shot operation mode can be cancelled by releasing the button to return to the target operation mode.

The icon 344 mainly comprises gauge lines 344a1 and 344a2 (the gauge line 344a2 is additionally displayed in the shot operation mode on the gauge line 344a1) which are partitioned into a plurality of areas indicative of the estimated flying distance, a meeting area 344b indicative of the effective range of shooting operation on the gauge line 344a1, a power gauge 344c indicative of the magnitude of impact on the gauge line 344a1, an impact pointer 344d indicative of the synchronization delay and the shooting timing in relation to the character, and a power shot trigger 344e1 indicative of the starting of “power shot” with the additional magnitude of impact in accordance with the acceleration during the shooting motion. Incidentally, this graphic user interface 344 can be reversed in the left-right direction in accordance with user operation such that the graphical representation can be switched in the direction conforming with the dominant hand of the operator.

The gauge lines 344a1 and 344a2 are a graphical representation for displaying the maximum value of the magnitude of impact as input (estimated flying distance), and provided with target points 344h1 and 344h2 (the target point 344h2 is additionally displayed in the shot operation mode) indicative of the magnitude of impact the operator desires, a shot point 344f indicative of appropriate shooting timing, and a controller icon 344g indicative of the state of the controller operated by the operator. The controller icon 344g is a first graphical representation for displaying the input value as an image which varies in response to the first manipulation signal, and provided with an icon 344g1 for informing the operator of how to use the controller, an icon 344g2 for representing the length of take-back motion in accordance with the acceleration and inclination of the controller 1c. This controller icon 344g moves (changes) in the horizontal direction as the first graphical representation in accordance with the first operation signal (the acceleration and inclination of the controller 1c).

Incidentally, the controller icon 344g can move as the first graphical representation beyond the target point 344h2 and reach the power shot trigger 344e1. A power shot can be started by moving the controller icon 344g to the power shot trigger 344e1.

When a target icon 35c is moved to an arrival point in the 3D golf course in advance of starting a shooting motion (in the target operation mode), the target point 344h1 moves on the gauge line 344a1 in accordance with the distance between the player and this target icon. The target icon 35c serves as an indication pointing to an estimated arrival point at which the operator aims in the three-dimensional space 3.

An estimated flight path of the ball is illustrated between the position of the character 35a and the estimated arrival point.

The estimated flight path is modified and displayed in accordance with the inclination of the controller 1c with respect to the direction of gravity as illustrated in FIG. 11, and the input data is changed on the basis of the estimated flight path which is modified. Namely, in the case of the golf game of the present embodiment, the flight path changes (for example, fade or draw) depending upon how to grip, and is used to calculate the flying distance, course, required magnitude of impact of the ball and so forth.

The target point 344h1 is displayed to indicate the required magnitude of impact on the ball in accordance with the distance to the target icon 35c as a target power on the gauge line 344a1. The estimated flight path of this ball is displayed as an estimated flight path 344j in association with the target power on the gauge line 344a1. Meanwhile, this estimated flight path 344j is a line plotted by projecting the estimated flight path onto a vertical surface in the three-dimensional space 3, and scaled in accordance with the length and display unit of the gauge line 344a1 (the maximum distance). The estimated flight path 344j is displayed to show not only the flight path but also change in the course (route) on the basis of obstacles, land form and the like. Furthermore, in the case of the present embodiment, a half swing mode is available to switch between a full swing mode and the half swing mode of the golf club which is selected, and the scaling of the estimated flight path 344j is switched in accordance with the maximum flying distance of each swing mode.

The shot point 344f indicates an appropriate shot point on the meeting area 344b displayed on the gauge line 344a2. The meeting area 344b is displayed to indicate the most effective shooting range in the vicinity of the shot point 344f. This effective shooting range changes in size in accordance with the type of crab the operator selected and the lie where the ball sits.

On the other hand, the gauge lines 344a1 and 344a2 and the power gauge 344c are a graphical representation indicative of the magnitude of impact actually input, and extended in accordance with the position of the impact pointer 344d to indicate the maximum input value of the magnitude of impact by the length (scale mark of the gauge line 344a). Furthermore, a limit on the maximum input value is indicated in the gauge lines 344a1 and 344a2 in accordance with the conditions of the objects, i.e., the lie where the ball sits (the states and conditions of grass and land form around the location). More specifically speaking, as illustrated in FIG. 5(c), the end of the gauge line 344a1 is provided with a texture 344i displayed to represent the lie over which the power gauge 344c cannot be extended so as to pose the limitation on the maximum value of the magnitude of impact which can be input. This texture 344i changes in length and image in accordance with the condition of the lie. For example, when the ball is located in a bunker, rough or the like, a sand image or grass field image is selected as the texture 344i whose length is adjusted in accordance with the difficulty level thereof.

The impact pointer 344d serves as a second graphical representation indicative of determination of the input value indicated by the first operation signal during the take-back motion of a shot and the start of accepting the second operation signal by changing an image when the take-back motion is switched to an swinging motion, and further serves as a third graphical representation indicative of the accepting of the second operation signal and the timing of modifying the input value determined by the second graphical representation. Namely, more specifically speaking, the impact pointer 344d moves as the first graphical representation in the rightward direction on the gauge line 344a to follow the controller icon 344g, reverses the motion as the second graphical representation after catching up with the controller icon 344g, and stops as the third graphical representation with timing (power) when a shooting motion is taken.

Describing in detail, as illustrated in FIG. 6(a), the controller icon 344g2 moves as the first graphical representation in the right and left direction in accordance with the first operation signal corresponding to the inclination of the controller 1c. At the same time, the character of the player slowly begins to take a motion following the motion of the operator on the basis of the first operation signal as input, and while the impact pointer 344d moves, the power gauge 344c is extended. In this case, the controller icon 344g1 is displayed to give the operator an image of the operation method of the controller 1c (inclining).

Next, as illustrated in the same figure (b), the following motion of this character is represented by the delay (difference) of the impact pointer 344d (the power gauge 344c) from the controller icon 344g2. Then, when the motion of the character is synchronized with the motion of the operator, i.e., the impact pointer 344d catches up with the controller icon 344g2 as the second graphical representation, the motion is automatically switched to the swinging motion, and the impact pointer 344d reverses its motion to start moving toward the shot point 344f and start accepting the second operation signal. The operator can change the position of the controller icon 344g1, just before reversing the motion, by changing the inclination of the controller 1c to adjust the timing of synchronizing with the character, i.e., the input value of the magnitude of impact. Also, during reversing the motion, the way of displaying the controller icon 344g2 is switched to notify the operator of the operation “swing”.

Thereafter, as illustrated in FIG. 6(c), the impact pointer 344d reverses and starts moving toward the shot point 344f, and if the operator takes a shot by swinging the controller 1c while the impact pointer 344d is moving in the meeting area 344b, the second operation signal is input so that the impact pointer 344d stops in the time (power) position corresponding to the input timing to complete the shooting motion. Meanwhile, the speed of swinging the controller 1c during a shot is calculated on the basis of the distribution and accumulated value of the second operation signal acquired while the impact pointer 344d is moving in the meeting area 344b.

Power shot gauges 344e2 and 344e3 shown in FIG. 7(a)-FIG. 7(c) are a fourth graphical representation indicative of change in the input value on the basis of the magnitude of acceleration contained in the second operation signal. The maximum magnitude of impact, which has been modified in accordance with the shot timing, is further modified and increased in accordance with the speed of swinging the controller 1c during a shot followed by showing an power increment just after the shooting motion as an extended gauge 344e3 on the power gauge 344c.

The input data of the magnitude of impact on this golf ball 35b is arithmetic processed by the application running unit 25 to proceed with the game in accordance with the changing position of the golf ball 35b. FIG. 8 is a block diagram for showing the configuration of a shooting power input system of the application running unit 25.

The application running unit 25 is provided with an operation signal acquisition unit 255 as a module for acquiring and arithmetic processing an operation signal which is input from the controller 1c. The operation signal acquisition unit 255 is connected with an acceleration calculating unit 257 and an inclination calculating unit 258 for calculating the acceleration and inclination of the controller 1c respectively on the basis of the operation signal, an input analysis unit 259 for analyzing the operation signal input through devices such as buttons and keys other than sensors, and an accumulated value calculating unit 256 for calculating the accumulated value of signals within a predetermined time period.

The operation signal acquisition unit 255 is a module for acquiring and discriminating a variety of operation signals and dispatching the values of the operation signals to the modules that need these values respectively, in order to receive the first operation signal indicative of starting a shooting motion and the second operation signal indicative of inputting the magnitude of impact. The acquired operation signals are input to a gauge control unit 253 through a character synchronization unit 254.

The acceleration calculating unit 257 and the inclination calculating unit 258 are modules for calculating the centrifugal force exerted on the controller 1c and the rotation and inclination of the controller 1c on the basis of the accelerations in the directions (X-axis, Y-axis, Z-axis) respectively detected by the acceleration sensor located in the controller 1c. Particularly, the inclination calculating unit 258 determines the direction of gravity exerted on the controller 1c and calculates the inclination in relation to the direction of gravity. Also, the accumulated value calculating unit 256 is a module for obtaining the accumulated value of the operation signals which have been acquired in the predetermined period. For example, this accumulated value calculating unit 256 can calculate the magnitude of impact on the basis of the accumulated value of the second operation signal obtained in the meeting area 344b. In this way, while it is possible to detect the acceleration continuously exerted for a predetermined period and prevent false detection of operation, the operator has to maintain the acceleration for a predetermined period and is required to perform large motion rather than short motion, resulting in an improved likeness to real sports.

The input analysis unit 259 is a module for detecting operation signals acquired from devices other than the acceleration sensor, for example, to extract and output a voice input signal or a button operation signal of the controller 1c to the gauge control unit 253 and other modules.

In the case of the present embodiment, the imaging screens 31 to 33 are used to display images taken at multiple angles by the virtual cameras located in the three-dimensional space 3, and the controller 1c is provided with a camera control function to control the imaging angles of the virtual cameras in accordance with the acceleration detected by the acceleration sensor. In this case, when controlling the target, as illustrated in FIG. 12, it is possible to display a shot mode screen (a closeup of character's feet, the overall image of the character, the imaging screen 33 and so forth) by tilting the controller 1c downward, display the imaging screen 32 (jump view) by evening out the controller 1c, and display the imaging screen 31 (top view) by tilting the controller 1c upward.

Meanwhile, when performing the camera control function, the operator does usually not perform a shooting motion so that sound appropriate for the displayed scenery may be output in accordance with the operation (camera switching operation) of the controller 1c. For example, the cheers and boos of the surrounding gallery may be output when displaying a jump view or top view.

This camera control function is turned on/off by pressing a predetermined button of the controller 1c. The camera control function is turned on when displaying the basic screen (in the game progress screen when a shooting motion is not performed). The camera control function is turned off by pressing the predetermined button for switching to a shooting motion (starting acquiring the first manipulation signal).

The input analysis unit 259 analyzes user operation of pressing a button, and issues an instruction to switch between the camera control function and the start of inputting the first operation signal. In response to this switch instruction, an input data generation unit 251 and the gauge control unit 253 start a shooting motion. Meanwhile, in the case of the present embodiment, an estimated flight path is determined when the camera control function is turned off to start a shooting motion. In other words, the estimated flight path is displayed in different ways as illustrated in FIG. 9 by tilting (rotating) the controller 1c when performing the camera control function. This represents the grip on a golf club such that the angle of the club face is estimated from the holding of the golf club to simulate the rotation and flight variation (fade or draw) of the ball. Then, when the button of the controller 1c is pressed, the input analysis unit 259 detects this operation to switch the camera control function to a shooting motion and determine the estimated flight path at the same time.

Furthermore, the application running unit 25 is provided with the gauge control unit 253, the input data generation unit 251 and the object control unit 252 respectively as modules for generating input data and controlling the objects.

The gauge control unit 253 performs graphic operation such as switching the way of displaying the graphic user interface 344, and serves as a module for inputting the magnitude of impact to the input data generation unit 251 through the controller. The gauge control unit 253 is provided with an impact pointer display unit 253a which controls the motion and display of the impact pointer 344d.

The 2D configuration unit 26 is a module for generating input data from the first operation signal indicative of the input value which varies in accordance with the operation of the controller 1c by the operator, and the second operation signal which modifies the input value. The generated input data is output to the object control unit 252.

On the other hand, the gauge control unit 253 is provided with the functionality of acquiring the position of the target icon 35c which is moved in the screen. The target icon 35c is a symbol pointing to the arrival point of the ball in the three-dimensional space 3 when performing a shooting motion, for example, as illustrated in FIG. 3. Two-dimensional motion of the target icon 35c in the screen is acquired in accordance with the user operation of the target icon 35c, i.e., this arrival point, and the target point 344h is displayed in accordance with the distance between the player and the target icon 35c.

The object control unit 252 calculates the flying distance of the ball and the coordinates after flying on the basis of the input data which is input. The 3D configuration unit 23 constructs a 3D animation on the basis of the coordinates after flying, and the 2D configuration unit 26 generates a two-dimensional image to be two-dimensionally displayed in each imaging screen which is displayed on the display 11 through the display interface 14.

Furthermore, the application running unit 25 is provided with the game progressing unit 281 as a module for proceeding the game, the operation signal evaluating unit 283 for evaluating operation signals, and the output information determining unit 284.

The game progressing unit 281 is a module for proceeding with the game by repeating according to a predetermined rule an operation signal input turn for receiving an input of an operation signal and an object varying turn for varying the display of an object by computation corresponding to the operation signal, and operable to control the operation of other modules such as the object control unit 252.

The operation signal evaluating unit 283 is a module for setting an evaluation criterion according to the setting operation by the operator and evaluating the operation signal from the controller with reference to the evaluation criterion, and the output information determining unit 284 is a module for determining the output of the sound information corresponding to the evaluation. Then, in the operation signal input turn, while the operation signal evaluating unit 283 acquires an operation signal from the controller 1c through the operation signal acquisition unit 255, the operation signal evaluating unit 283 performs evaluation of the operation signal, followed by outputting sound information determined by the output information determining unit 284 in accordance with the evaluation through the speaker 1d of the controller 1c.

For example, when the player sets up the position of the controller 1c for taking a shot during, playing the golf game, advise such as guidance can be readily provided to personify the controller as an adviser like a caddie.

On the other hand, the object control unit 252 is provided with a gallery control unit 282 which determines, when a plurality of controllers are connected as the controller 1c, the output of sound information or the operation of an object which is assigned to each controller in accordance with the operation signal output from any controller. In the operation signal input turn of one controller, this gallery control unit 282 performs, in response to an operation signal output from another controller, the output of sound information or the operation of an object which is assigned to this another controller.

When a plurality of operators participate in the game by using controllers respectively, in the operation signal input turn of one player (for operation other than a shooting operation (for example, the target operation mode)), this gallery control unit 282 makes it possible for other players waiting their turns to output cheers, boos, advice and the like by swinging their controllers. Meanwhile, in this case, while the controllers may be controllers belonging to other game machines which communicate with this game machine through a communication line, the game progressing unit 281 operates to proceed with the same game among the plurality of game machines by synchronous process with the other game machines.

(Game Machine Control Method and Object Operation Method)

The object operation method and game machine control method of the present invention can be implemented by operating the game machine having the structure as described above. FIG. 9 is a flow chart for showing the process of proceeding with the game, and FIG. 10 is a flow chart for showing the input process of a shooting motion of the game machine in accordance with the present embodiment.

Basically, as illustrated in FIG. 9, the operator is switched in turn (S206) while alternately repeating according to a predetermined rule the operation signal input turn (S100) for receiving an input of an operation signal and the object varying turn (S205) for varying the display of an object in order to proceed with the game machine.

In step S100, target operation and gallery control (S114) and the shot operation mode (S200) are repeated by a loop process. When the shot operation is completed, the process proceeds to the object varying turn in step S205.

In the target operation mode (S114), the target icon 35c is moved to an arrival point in the 3D golf course in advance of starting a shooting motion. By this process, an estimated flight path of the ball is illustrated between the position of the character 35a and the target icon 35c (the estimated arrival point). Furthermore, when performing the gallery control in step S114 in the operation signal input turn assigned to one controller, the gallery control unit 282 performs, in response to an operation signal output from another controller, the output of sound information or the operation of an object which is assigned to this another controller. For example, in the target operation mode of one player, other players waiting their turns can output cheers, boos, advice and the like by swinging their controllers.

Then, in step S101, it is determined whether or not a shooting motion is started by monitoring operation of the operator, and the process proceeds to the shot operation mode in step S200 in response to the address operation of the operator (tilting the controller 1c downward with the A or B button being pressed). In this case, the shot is recognized as an effective shot (the ball is actually hit) if A button is pressed, or as a practice swing (the ball is actually not hit) if B button is pressed. When the operator starts a take-back motion in step S101 (i.e., the “Y” branch from step S101) with either button of the controller 1c being pressed, the camera control function is turned off for switching to a shooting motion (starting acquiring the first manipulation signal). The inclination of the controller 1c is detected with the button being pressed, and the estimated flight path is determined in accordance with the face angle of the golf club. Incidentally, when entering the shot operation mode, the gallery control mode and target operation mode are completed.

In the shot operation mode (S200), as illustrated in FIG. 10, the shot operation process (S102 through S113) and the operation signal evaluating process (S201 through S203) are concurrently performed. The operation signal evaluating process is performed to acquire an operation signal through the operation signal acquisition unit 255 in step S201, evaluate the acquired operation signal with reference to the evaluation criterion in step S202, and output sound information determined in accordance with the evaluation from the speaker 1d of the controller which receives input operation in step S203. This evaluation criterion is given as a threshold value which is a target value determined by selecting an operation as the evaluation subject through the icon 343, and the evaluating process is performed by comparing the input value of the operation signal with the threshold value, determining whether or not the target value is reached, and perform evaluation with regard to how to achieve the target.

Next, in step S203, it is determined to output sound information in accordance with the evaluation in the operation signal evaluation step (S202). This sound information is audio data of guidance accumulated as a database. The output determination process is performed to select audio data in accordance with the evaluation subject as selected, the target value and the degree of deviation from the target, and extract the audio data.

In the shot operation mode, when the operator swings the controller 1c as a take-back motion in step S101, the operation signal acquisition unit 255 acquires the first operation signal in step S102 in accordance with the inclination of the controller 1c.

The controller icon 344g moves in the right and left direction on the basis of this first operating signal in step S104, and the character slowly begins to perform a take-back motion following the motion of the operator on the basis of the first operating signal as input in step S103. The following motion of this character is represented by the delay (difference) of the impact pointer 344d from the controller icon 344g.

During this process, the operator continues to press the button of the controller 1c (i.e., the “N” branch from step S105). When releasing this button (i.e., the “Y” branch from step S105), the swinging motion is aborted (canceled) to return to step S101 in which the operation can be retried.

While the motion of the character does not yet complete synchronization but generates the difference (i.e., the “N” branch from step S106) rather than cancelled, the first operating signal is continuously acquired, and the operator can change the position of the controller icon 344g by changing the inclination of the controller 1c to adjust the timing of synchronizing with the character, i.e., the input value of the magnitude of impact. Meanwhile, depending upon the lie where the ball sits in this case, the texture 344i is displayed on the gauge line 344a in accordance with this lie to pose a limit on the length of the power gauge 344c and a limit on the magnitude of impact input by the take-back motion.

Then, when the operator and the character are synchronized with each other in motion and the impact pointer 344d catches up with the controller icon 344g (i.e., the “Y” branch from step S106, the maximum input value (the maximum magnitude value of impact) corresponding to the first operating signal is determined in step S107 and the motion is automatically switched to the swinging motion. In this swinging motion, the impact pointer 344d reverses and starts moving toward the shot point 344f in step S108. The speed of the impact pointer 344d after reversing varies depending upon the reversing position to increase as the magnitude of impact increases, and further increase as the impact pointer 344d approaches the power shot gauge 344e beyond the gauge line 344a. That is, while the magnitude of impact becomes greater when the impact pointer 344d moves beyond the gauge line 344a, the speed after reversing becomes so high as to make it difficult to hit the ball with correct timing. In this case, if the reversing position is in the power shot gauge 344e, it is possible to take a power shot.

Next, the impact pointer 344d moves toward the shot point 344f, and comes into the meeting area 344b such that it is ready to accept the second operating signal by repeating a loop process while the impact pointer 344d is moving in the meeting area 344b (i.e., the “N” branch from step S109 and step S110). Then, if the operator performs a shooting motion by swinging the controller 1c while the impact pointer 344d is moving in the meeting area 344b, the second operating signal is acquired (i.e., the “Y” branch from step S109) so that the impact pointer 344d stops in step S111 to complete the shooting motion. Incidentally, the speed of swinging the controller 1c during a shot is calculated on the basis of the distribution and accumulated value of the second operating signal acquired while the impact pointer 344d is moving in the meeting area 344b.

On the other hand, if the impact pointer 344d is moving in the meeting area 344b without acquisition of the second operating signal in step S109 (i.e., the “Y” branch from step S110), the value of the second operating signal is compulsorily determined to perform the shooting motion in step S111. The input value of the compulsory shooting motion may, for example, be determined as a random value or a lowest value.

Input data is generated in step S112 after acquiring both the second operating signal and the first operating signal in step S108. In this case, the value of the first operating signal (the maximum magnitude value of impact) is modified in accordance with the timing, face angle and spinning operation of the shooting motion in step S111, and further increased in accordance with the speed of swinging the controller 1c when acquiring the second operating signal (during the shooting motion). The power increment is displayed by the power shot gauge 344e in step S113 just after the shooting motion. Thereafter, if the shooting motion is an effective shot, the shot operation (subroutine S200) is finished and returned to the routine S100 (i.e., the “N” branch from step S204). If the shooting motion is a practice swing (i.e., the “Y” branch from step S204), the process proceeds to step S114 in the routine S100 in which the target operation and gallery control are resumed to wait for the next shooting motion in step S101.

If the shooting motion is an effective shot, the process exits the loop in the operation signal input turn S100 and proceeds to the object varying turn S205 after the shot operation is finished. In this object varying turn S205, the object is controlled (i.e., the ball is moved) on the basis of the flying distance, the shooting direction, the course of the flying ball, the rotation of the ball, the ball behavior after landing and so forth which are calculated in accordance with the generated input data (the maximum magnitude of impact, the modified value), followed by switching to the next player in step S206.

(Object Control Program)

The game machine, control method thereof and object control method as described above in accordance with the present embodiment can be performed in a computer by running an input program described in a predetermined language. Namely, the system having the functionality as described above can easily be implemented by installing the program in a user terminal, a personal computer such as a Web server, an IC chip and so forth, and running the program on the CPU 2. This program can be distributed, for example, through a communication line, or as a package application which can be run on a stand-alone computer.

In addition, such a program can be stored in a computer readable medium, so that the game machine and object control method as described above can be implemented with a general purpose computer or a dedicated computer, and the program can be easily maintained, transported and installed.

(Effect/Action)

As has been discussed above, in accordance with the present embodiment, when the operator sets up the position of the controller 1c for inputting an operation signal in the operation signal input turn, sound information such as guidance or advise relating to the input operation is output through the speaker 1d of the controller 1c at hand in appropriate timing during playing the game on the basis of the evaluation of the operation signal, and thereby the controller 1c can be personalized as an adviser such as a caddie with sound to make alive the golf and help the operator to become skillful in playing the game.

Also, when a plurality of operators participate in the game by using controllers respectively, in the turn of one player, other players waiting their turns can output cheers, boos, advice and the like by operating their controllers 1c, and thereby it is possible to personify the controllers of the other players as gallery, and improve the realistic sensation and entertaining capability of the game.

Furthermore, in the case of the present embodiment, it is possible to determine the timing with the controller 1c having the built-in acceleration sensor, even in the case where a plurality of motions are input as a set of motions such as a take-back motion, a swinging motion and a shooting motion in a golf game, by detecting only the start and end of the motions as the first operating signal and the second operating signal and detecting the timing of switching the motions on the basis of the synchronization with the motion of the character (the second graphic representation). Because of this, in the case of the present embodiment, it is possible to dispense with the operation, for switching between the motions, which is unnecessary when actually doing sports, and acquire important operating signals which determine input data by more similar motions as in actually doing sports.

Particularly, in the case of the present embodiment, the operating signal relating to the next operation is accepted on the basis of the synchronization between the motion of the operator and the motion of the character in the screen, and thereby the operator can spontaneously switch to the next motion for inputting an operating signal while feeling the sense of identity to the character in the screen.

Also, in the case of the above embodiment, it is possible to acquire not only the timing of inputting but also the power (extent) of the motion when accepting the second operating signal through the power shot gauge 344e (the fourth graphic representation), and notify the operator of the result of acquisition to diversify the game scenario. While the maximum magnitude of impact is determined by synchronization with the character during a take-back motion in the case of the present embodiment, the magnitude of impact can be increased by the speed of swinging for inputting the second operating signal, even after failing to perform this take-back motion. As a result, the magnitude of impact can be adjusted also by the speed (strength) of swinging the controller 1c to make the game more exciting, while maintaining the operability in a realistic situation. Also, the maximum value of the take-back motion is limited by the texture 344i on the gauge line 344a in accordance with the lie where the ball sits (the states and conditions of grass and land form around the location), and thereby the condition of the golf course and obstacles can be represented by difficulty in operability to make the game more exciting.

(Modification Example)

The present invention is not limited to the above embodiment, but it is possible to add a variety of modification. For example, in the case of the above embodiment, the second graphic representation of the above embodiment is used to show synchronization between the motion of the operator and the motion of the character for switching to the accepting of the second operating signal. However, for example, the second graphic representation may be such that the time elapsed after the start of inputting the first operating signal is displayed, and when the elapsed time reaches a predetermined time the determination of an input value and the start of accepting the second operating signal are indicated. In this case, it is possible to provide a simple representation of switching between motions in an easy-to-understand manner by indicating switching from a first motion to the next motion with reference to the elapsed time of a timer or the like.

Alternatively, the second graphic representation may be such that the operator is prompted to determine a power level by pressing the A button of the controller 1c or the like. In this case, an impact may be exerted by taking a swinging motion in synchronization with the moving gauge in the third graphic representation. Furthermore, the second graphic representation may represent inversion of the acceleration detected by the acceleration sensor. Namely, switching from a take-back motion to a swinging motion is detected when the inclination and acceleration of the controller 1c start changing backward, and power determination is performed when the acceleration is reversed. Furthermore, the input value of the first operating signal may be determined in advance. For example, the first operating signal may be set to the input value determined when the arrival point of the ball is set up by placing the target icon as described above. In this case, only the timing of the swinging motion has to be detected, but the take-back motion need not be detected. Incidentally, while the value of the second operating signal is obtained as the accumulated value in the predetermined time in the case of the present embodiment, the value of the second operating signal may be determined by the instantaneous acceleration (the strength of the swinging motion).

Furthermore, the differential motion between the character and the operator may be represented by displaying double the character. That is to say, the character which is an entity actually operated by the operator and the character following the operator with a delay are doubly displayed. In this case, while the take-back motion (power) is represented by the inclination of the controller 1c, “the degree of catching up with” is displayed separately therefrom. For example, it is conceivable to display an impact determination gauge of a basic upward motion (to determine at 100%), a gauge decreasing simultaneously when the power is increasing, an explanation which does not associate two objects, i.e., the power and the degree of catching up with. In this case, the impact determination gauge of the basic upward motion may be decreased in accordance with the angular momentum of the input device.

### BRIEF DESCRIPTION OF DRAWINGS

FIG. 1 A view for schematically showing the system configuration of the game machine in accordance with an embodiment.

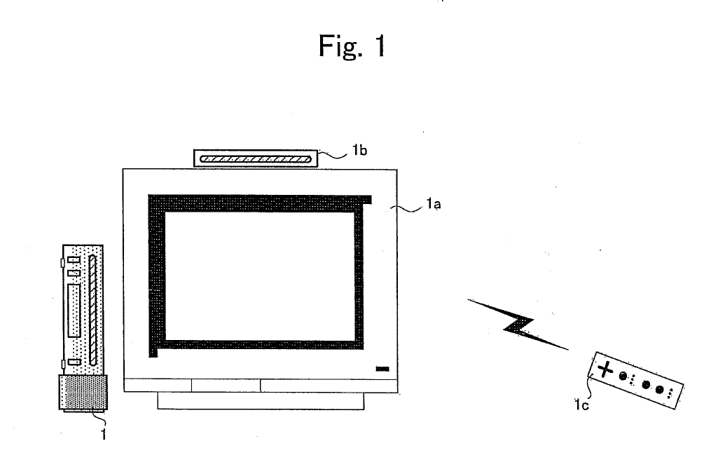

FIG. 2 An explanatory view for showing the operation method of the controller in accordance with the embodiment.

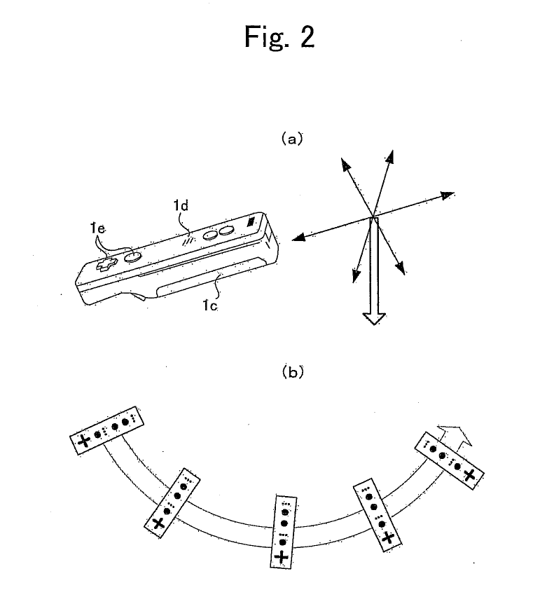

FIG. 3 An explanatory view for showing the screen layout of the 3D game machine in accordance with the embodiment.

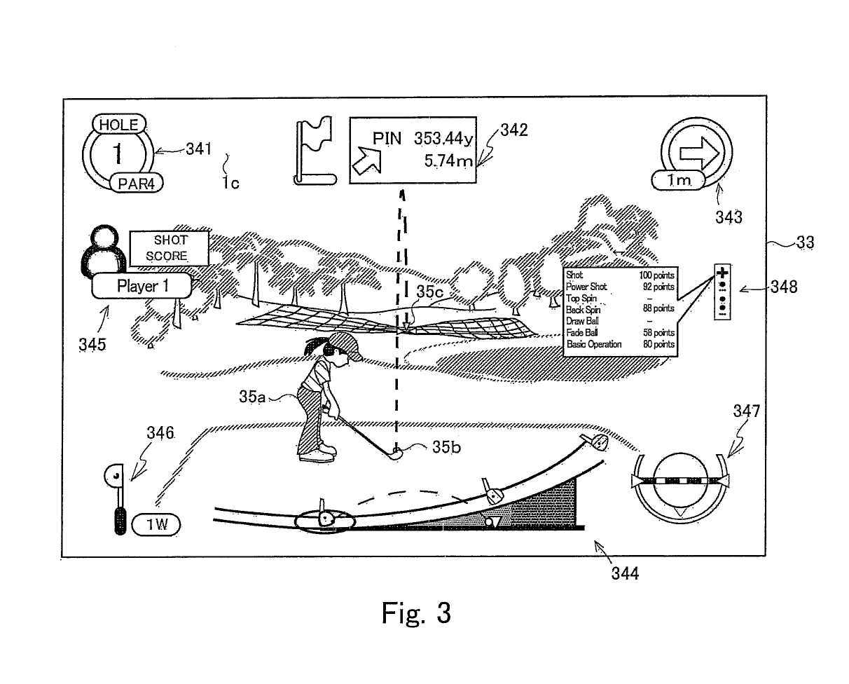

FIG. 4 A block diagram for showing the internal configuration of the game machine in accordance with the embodiment.

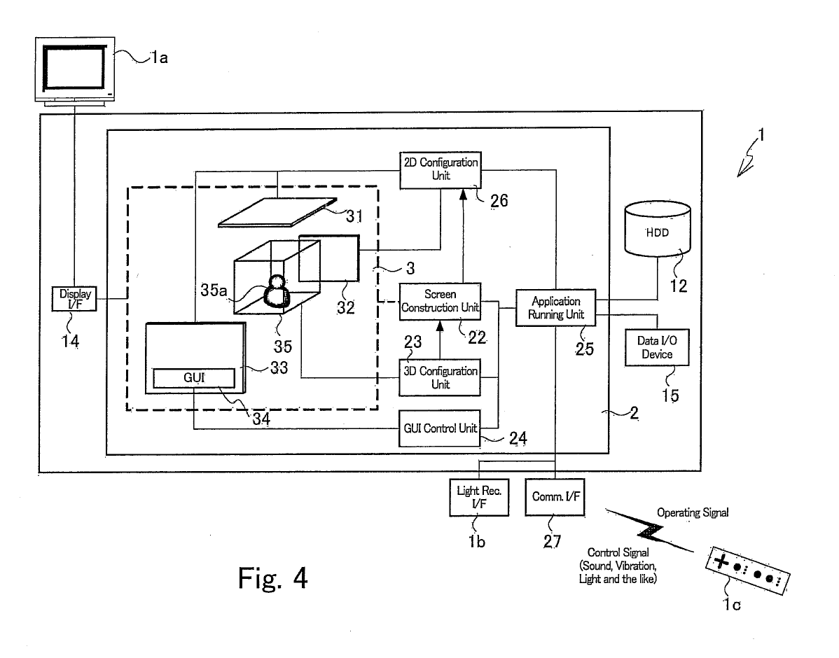

FIG. 5 A view for schematically showing the configuration of the GUI in accordance with the embodiment.

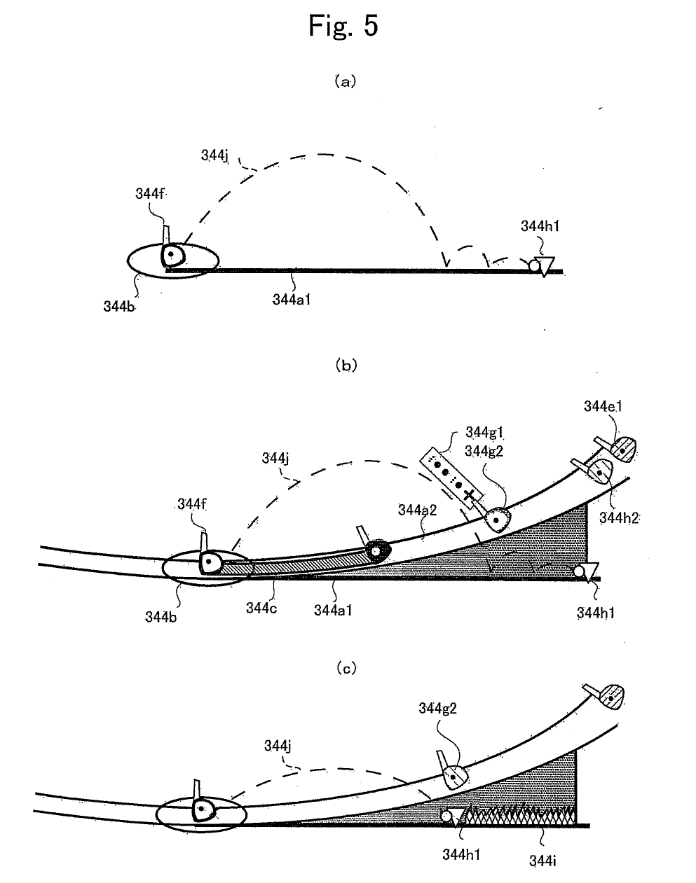

FIG. 6 An explanatory view for showing the operation of the GUI during the shooting motion for a normal shot in accordance with the embodiment.

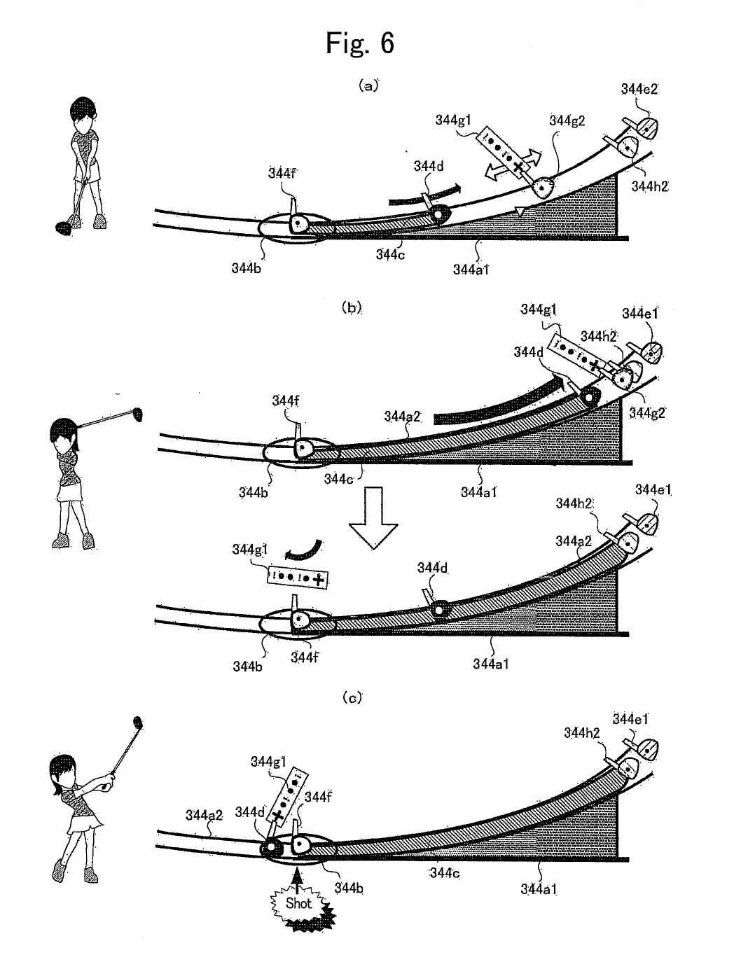

FIG. 7 An explanatory view for showing the operation of the GUI during the shooting motion for a power shot in accordance with the embodiment.

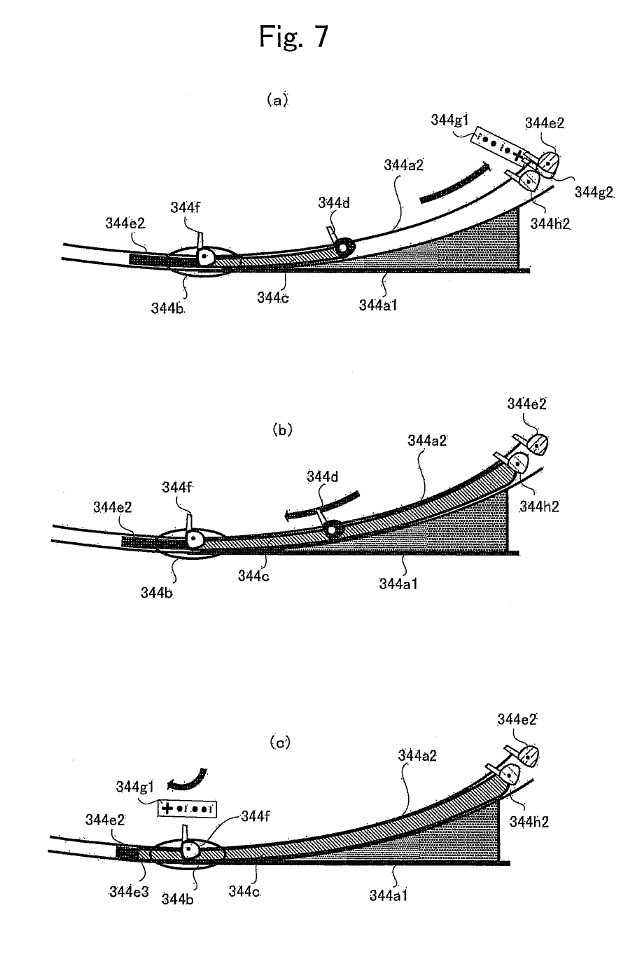

FIG. 8 A block diagram for showing the configuration of the application running unit 25.

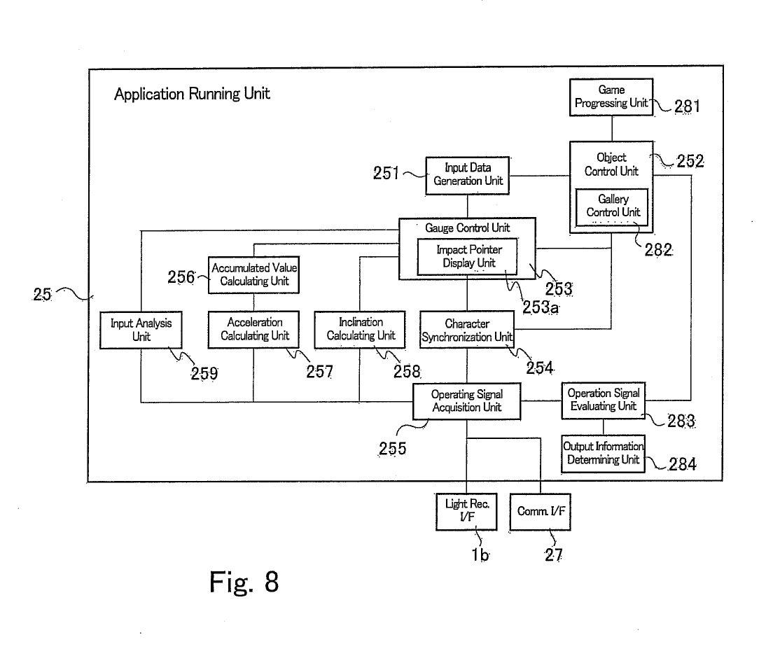

FIG. 9 A flow chart for showing the game progress process of the game machine in accordance with the embodiment.

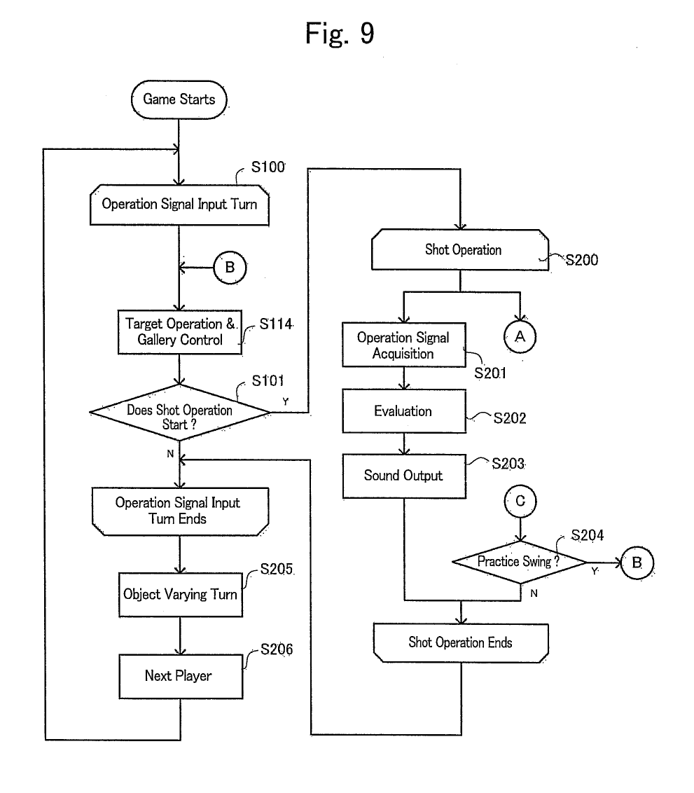

FIG. 10 A flow chart for showing the input process when performing a shooting motion with the game machine in accordance with the present invention.

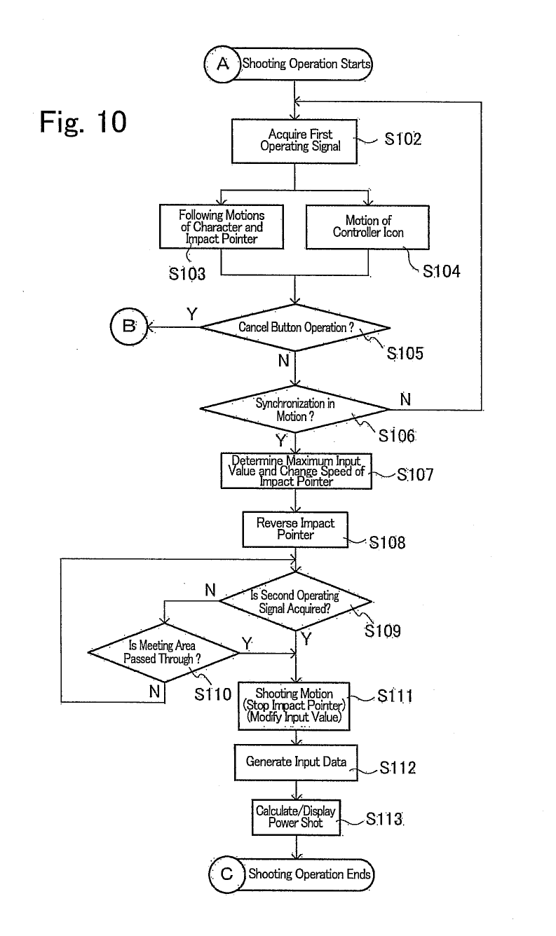

FIG. 11 An explanatory view for showing the displaying of the estimated flight path of the game machine in accordance with the embodiment.

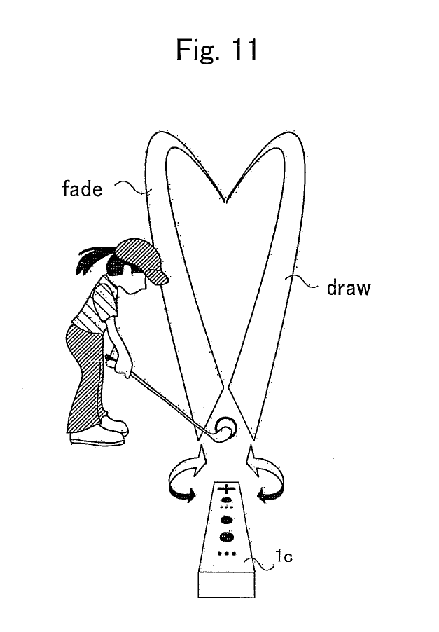

FIG. 12 An explanatory view for showing the camera control function of the game machine in accordance with the embodiment.

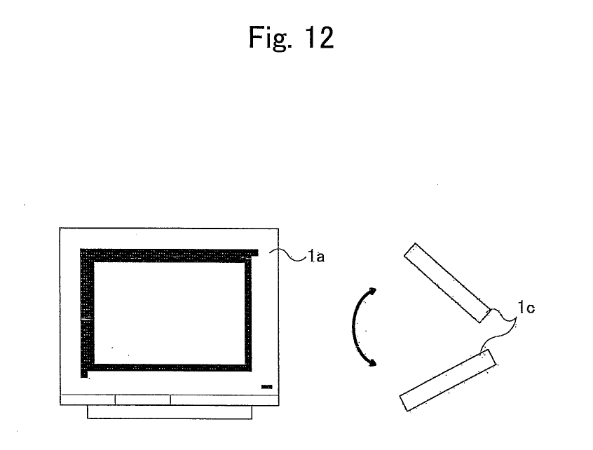

### EXPLANATION OF REFERENCE

1 . . . gaming hardware
1a . . . display
1b . . . light receiving interface
1c . . . controller
1d . . . speaker
1e . . . operation button
2 . . . CPU
3 . . . three-dimensional space
11 . . . display
12 . . . storage device
14 . . . display interface
15 . . . data input/output device
22 . . . screen construction unit
23 . . . 3D configuration unit
24 . . . GUI control unit
25 . . . application running unit
26 . . . 2D configuration unit
27 . . . communication interface
31˜33 . . . imaging screen
34 . . . GUI
35 . . . three-dimensional coordinate system
35a . . . character
35b . . . golf ball
35c . . . target icon
251 . . . input data generation unit
252 . . . object control unit
253 . . . gauge control unit
253a . . . impact pointer display unit
254 . . . character synchronization unit
255 . . . operating signal acquisition unit
256 . . . accumulated value calculating unit
257 . . . acceleration calculating unit
258 . . . inclination calculating unit
259 . . . input analysis unit
281 . . . game progressing unit
282 . . . gallery control unit
283 . . . operation signal evaluating unit
284 . . . output information determining unit
344˜348 . . . graphic user interfaces (icon)
344a1, 344a2 . . . gauge line
344b . . . meeting area
344c . . . power gauge
344d . . . impact pointer
344e1 . . . power shot trigger
344e2 . . . power shot gauge
344f . . . shot point
344g1, 344g2 . . . controller icon
344h1, 344h2 . . . target point
344i . . . texture icon
344j . . . estimated flight path

1. A game machine for proceeding with a game by inputting an operating signal to operate an object displayed in a screen, comprising:
a game progressing unit operable to proceed with the game by repeating according to a predetermined rule an operation signal input turn for receiving an input of the operation signal and an object varying turn for varying the display of the object by computation corresponding to the operation signal;
a controller provided with an acceleration sensor for detecting acceleration in a predetermined direction and configured to output the operating signal in accordance with the acceleration detected by the acceleration sensor;
a sound output unit provided for the controller and operable to output sound information;
an operation signal evaluating unit operable to set an evaluation criterion according to the setting operation by the operator and evaluating the operation signal from the controller with reference to the evaluation criterion; and
an output information determining unit operable to determine the output of sound information corresponding to the evaluation by the operation signal evaluating unit,
wherein, in the operation signal input turn, an operation signal is acquired from the controller; the acquired operation signal is evaluated by the operation signal evaluating unit; the output information determining unit determines sound information in accordance with the evaluation; and the sound information is output through the controller from which the operation signal is input.

2. A game machine for proceeding with a game by inputting an operating signal to operate an object displayed in a screen, comprising:
a game progressing unit operable to proceed with the game by repeating according to a predetermined rule an operation signal input turn for receiving an input of the operation signal through each of a plurality of controllers and an object varying turn for varying the display of the object by computation corresponding to the operation signal;
the plurality of controllers each of which is provided with an acceleration sensor for detecting acceleration in a predetermined direction and configured to output the operating signal in accordance with the acceleration detected by the acceleration sensor;
a gallery control unit operable to determine the output of sound information or the operation of an object which is assigned to each of the controllers in accordance with the operation signal output from any of the controllers,
wherein in the operation signal input turn assigned to one controller, the gallery control unit performs, in response to an operation signal output from another controller, the output of sound information or the operation of an object which is assigned to this another controller.

3. The game machine as claimed in claim 2 wherein the controllers include controllers belonging to other game machines which communicate with this game machine through a communication line, and wherein the game progressing unit operates to proceed with the same game among the plurality of game machines by synchronous process with the other game machines.

4. A game program for proceeding with a game by:
using a controller provided with an acceleration sensor for detecting acceleration in a predetermined direction and a sound output unit for outputting sound information, and configured to output an operating signal in accordance with the acceleration detected by the acceleration sensor; and
changing an object displayed in a screen on the basis of the operating signal input through the controller, the game program causing a computer to perform:
a game progressing step of proceeding with the game by repeating according to a predetermined rule an operation signal input turn for receiving an input of the operation signal and an object varying turn for varying the display of the object by computation corresponding to the operation signal; and
an operation signal evaluating step of setting an evaluation criterion according to the setting operation by the operator;
an output information determining step of determining the output of the sound information in accordance with the evaluation in the operation signal evaluating step; and
an evaluation information output step of, in the operation signal input turn, acquiring an operation signal from the controller, evaluating the acquired operation signal in accordance with the evaluation criterion, outputting the sound information determined in accordance with the evaluation through the controller from which the operation signal is input.

5. A game program for proceeding with a game by:
using a plurality of controllers each of which is provided with an acceleration sensor for detecting acceleration in a predetermined direction and a sound output unit for outputting sound information, and configured to output an operating signal in accordance with the acceleration detected by the acceleration sensor;
changing an object displayed in a screen on the basis of an operating signal input through each of the controllers, the game program causing a computer to perform:
a game progressing step of proceeding with the game by repeating according to a predetermined rule an operation signal input turn for receiving an input of the operation signal through each of a plurality of controllers and an object varying turn for varying the display of the object by computation corresponding to the operation signal; and
a gallery control step of, in the operation signal input turn assigned to one controller and in response to an operation signal output from another controller, performing the output of sound information or the operation of an object which is assigned to this another controller.

6. The game program as claimed in claim 5 wherein the controllers include controllers belonging to other game machines which communicate with this game machine through a communication line, and wherein the plurality of game machines proceed with the same game by performing synchronous process among these game machines in the game progressing step.

7. A game machine control method for proceeding with a game by:
using a controller provided with an acceleration sensor for detecting acceleration in a predetermined direction and a sound output unit for outputting sound information, and configured to output an operating signal in accordance with the acceleration detected by the acceleration sensor; and
changing an object displayed in a screen on the basis of the operating signal input through the controller, the game machine control method comprising:
a game progressing step of proceeding with the game by repeating according to a predetermined rule an operation signal input turn for receiving an input of the operation signal and an object varying turn for varying the display of the object by computation corresponding to the operation signal; and
an operation signal evaluating step of setting an evaluation criterion according to the setting operation by the operator;
an output information determining step of determining the output of the sound information in accordance with the evaluation in the operation signal evaluating step; and
an evaluation information output step of, in the operation signal input turn, acquiring an operation signal from the controller, evaluating the acquired operation signal in accordance with the evaluation criterion, outputting the sound information determined in accordance with the evaluation through the controller from which the operation signal is input.

8. A game machine control method for proceeding with a game by:
using a plurality of controllers each of which is provided with an acceleration sensor for detecting acceleration in a predetermined direction and a sound output unit for outputting sound information, and configured to output an operating signal in accordance with the acceleration detected by the acceleration sensor;
changing an object displayed in a screen on the basis of an operating signal input through each of the controllers, the game machine control method comprising:
a game progressing step of proceeding with the game by repeating according to a predetermined rule an operation signal input turn for receiving an input of the operation signal through each of a plurality of controllers and an object varying turn for varying the display of the object by computation corresponding to the operation signal; and
a gallery control step of, in the operation signal input turn assigned to one controller and in response to an operation signal output from another controller, performing the output of sound information or the operation of an object which is assigned to this another controller.

9. The game machine control method as claimed in claim 8 wherein the controllers include controllers belonging to other game machines which communicate with this game machine through a communication line, and wherein the plurality of game machines proceed with the same game by performing synchronous process among these game machines in the game progressing step.
